(19) United States
(12) Patent Application Publication
(10) Pub. No.: US 2023/0396857 A1
(43) Pub. Date: Dec. 7, 2023

(54) VIDEO GENERATION METHOD AND APPARATUS, AND ELECTRONIC DEVICE AND COMPUTER-READABLE MEDIUM

(71) Applicants: Beijing Wodong Tianjun Information Technology Co., Ltd., Beijing (CN); Beijing Jingdong Century Trading Co., Ltd., Beijing (CN)

(72) Inventors: Xiaojuan Liu, Beijing (CN); Le Liu, Beijing (CN)

(73) Assignees: Beijing Wodong Tianjun Information Technology Co., Ltd., Beijing (CN); Beijing Jingdong Century Trading Co., Ltd., Beijing (CN)

(21) Appl. No.: 18/033,671

(22) PCT Filed: Oct. 26, 2021
(86) PCT No.: PCT/CN2021/126427

§ 371 Date: Apr. 25, 2023

(30) Foreign Application Priority Data
Oct. 30, 2020 (CN) 202011192359.5

(51) Int. Cl. H04N 21/81; H04N 21/254; H04N 21/431; H04N 21/845

(52) U.S. Cl. CPC H04N 21/812; H04N 21/2542; H04N 21/4312; H04N 21/8456

(57) ABSTRACT

A video generation method and apparatus. The method may include: determining one template from multiple types of templates as a production template on the basis of an input instruction of a user (201); in response to determining that the type of commodity information inputted by the user is matched with the type of the production template, obtaining a commodity picture or commodity video material related to the commodity information (202); and processing the commodity picture or commodity video material on the basis of the production template to generate a commodity video (203).

This patent application is a National Stage of International Application No. PCT/CN2021/126427, filed Oct. 26, 2021, which claims the priority to Chinese Patent Application No. 202011192359.5, filed on Oct. 30, 2020 and entitled “Method and Apparatus for Generating Video, Electronic Device, and Computer Readable Medium,” the disclosures of which are hereby incorporated by reference in their entireties.

### TECHNICAL FIELD

The present disclosure relates to the field of computer technology, in particular to the field of computer vision technology, and more particularly, to a method and apparatus for generating a video, an electronic device, and a computer readable medium.

### BACKGROUND OF THE INVENTION

Video generation refers to the editing of video clips that meet video semantics into a video, and an e-commerce scenario requires the generated video to be capable of displaying commodity characteristics in multiple aspects, multiple dimensions and multiple angles.

### SUMMARY OF THE INVENTION

Embodiments of the present disclosure propose a method and apparatus for generating a video, an electronic device, and a computer readable medium.

In a first aspect, an embodiment of the present disclosure provides a method for generating a video, including: determining a template from multiple types of templates as a production template based on an input instruction of a user; acquiring, in response to determining that a type of commodity information inputted by the user matches with a type of the production template, a commodity picture or a commodity video material related to the commodity information; and processing the commodity picture or the commodity video material based on the production template to generate a commodity video.

In some embodiments, processing the commodity picture or the commodity video material based on the production template to generate the commodity video, includes: transferring music in the production template or music in the commodity video material to a frequency domain, calculating local extrema of audio energy and misalignment convolution, and determining accent points and beats; generating the commodity picture into an initial video and extracting multiple video segments of a preset duration from the initial video, or extracting multiple video segments of a preset duration from the video material; and merging the multiple video segments in a form of transition animation based on the accent points and the beats, to generate the commodity video.

In some embodiments, acquiring, in response to determining that the type of commodity information inputted by the user matches with the type of the production template, the commodity picture or the commodity video material related to the commodity information, includes: judging, after the user logs in, whether the user has business registration information; acquiring, in response to a judgment result being that the user has the business registration information, basic information of a commodity on sale by the user based on the business registration information; determining the commodity information inputted by the user, based on an operation on the basic information by the user; and acquiring, in response to determining that the type of the commodity information inputted by the user matches with the type of the production template, the commodity picture or the commodity video material related to the commodity information; and prompting, in response to the judgement result being that the user does not have the business registration information, the user to input the commodity information, and acquiring, in response to determining that the type of the commodity information inputted by the user matches with the type of the production template, the commodity picture or the commodity video material related to the commodity information.

In some embodiments, the method further includes: acquiring a commodity detail page related to the commodity information, based on the commodity information; extracting key information in the commodity detail page; performing special effects processing on the key information, and writing the key information after the special effects processing into the commodity video; and performing filter and light and shadow effect processing on the commodity video in which the key information is written.

In some embodiments, extracting the key information in the commodity detail page, includes: extracting the key information in the commodity detail page using a language model, the language model being obtained from training based on the type of the production template.

In some embodiments, processing the commodity picture, includes: pre-processing the commodity picture; identifying a text area of the pre-processed picture; and removing text content in the text area.

In some embodiments, the method further includes: binding the commodity video to a commodity code; and uploading the commodity video bound to the commodity code to a promotional display position of a main picture of the commodity.

In some embodiments, the method further includes: sending, in response to determining that the type of the commodity information inputted by the user does not match with the type of the production template, a prompt message for prompting replacement of the production template.

In a second aspect, an embodiment of the present disclosure provides an apparatus for generating a video, the apparatus including: a determination unit, configured to determine a template from multiple types of templates as a production template based on an input instruction of a user; an acquisition unit, configured to acquire, in response to determining that a type of commodity information inputted by the user matches with a type of the production template, a commodity picture or a commodity video material related to the commodity information; and a generation unit, configured to process the commodity picture or the commodity video material based on the production template to generate a commodity video.

In some embodiments, the generation unit includes: a calculation module, configured to transfer music in the production template or music in the commodity video material to a frequency domain, calculate local extrema of audio energy and misalignment convolution, and determine accent points and beats; an extraction module, configured to generate the commodity picture into an initial video and extract multiple video segments of a preset duration from the initial video, or extract multiple video segments of a preset duration from the video material; and a generation module, configured to merge the multiple video segments in a form of transition animation based on the accent points and the beats, to generate the commodity video.

In some embodiments, the acquisition unit further includes: a judgement module, configured to: judge, after the user logs in, whether the user has business registration information; an acquisition module, configured to: acquire, in response to a judgment result being that the user has the business registration information, basic information of a commodity on sale by the user based on the business registration information; a determination module, configured to: determine the commodity information inputted by the user, based on an operation on the basic information by the user; a responding module, configured to: acquire, in response to determining that the type of the commodity information inputted by the user matches with the type of the production template, the commodity picture or the commodity video material related to the commodity information; and a prompting module, configured to: prompt, in response to the judgement result being that the user does not have the business registration information, the user to input the commodity information, and trigger the responding module to work.

In some embodiments, the apparatus further includes: a detailed unit, configured to acquire a commodity detail page related to the commodity information, based on the commodity information; an extraction unit, configured to extract key information in the commodity detail page; a special-effects unit, configured to perform special effects processing on the key information, and write the key information after the special effects processing into the commodity video; and a processing unit, configured to perform filter and light and shadow effect processing on the commodity video in which the key information is written.

In some embodiments, the extraction unit is further configured to: extract the key information in the commodity detail page using a language model, the language model being obtained from training based on the type of the production template.

In some embodiments, the generation unit includes: a pre-processing module, configured to pre-process the commodity picture; an identification module, configured to identify a text area of the pre-processed picture; and a removal module, configured to remove text content in the text area.

In some embodiments, the apparatus further includes: a binding unit, configured to bind the commodity video to a commodity code; and an uploading unit, configured to upload the commodity video bound to the commodity code to a promotional display position of a main picture of the commodity.

In some embodiments, the apparatus further includes: a sending unit, configured to send, in response to determining that the type of the commodity information inputted by the user does not match with the type of the production template, a prompt message for prompting replacement of the production template.

In a third aspect, an embodiment of the present disclosure provides an electronic device, the electronic device including: one or more processors; and a storage apparatus, storing one or more programs thereon. The one or more programs, when executed by the one or more processors, cause the one or more processors to implement the method as described in any one of the implementations in the first aspect.

In a fourth aspect, an embodiment of the present disclosure provides a computer readable medium, storing a computer program thereon. t when the program is executed by a processor, the method as described in any one of the implementations in the first aspect is implemented.

### BRIEF DESCRIPTION OF THE DRAWINGS

Other features, objectives and advantages of the present disclosure will become more apparent by reading detailed descriptions of non-limiting embodiments made with reference to the following accompanying drawings.

FIG. 1 is an exemplary system architecture diagram to which an embodiment of the present disclosure may be applied;

FIG. 2 is a flowchart of an embodiment of a method for generating a video according to the present disclosure;

FIG. 3 is a flowchart of a method for acquiring a commodity picture or a commodity video material related to commodity information according to the present disclosure;

FIG. 4 is a flowchart of another embodiment of the method for generating a video according to the present disclosure;

FIG. 5 is a schematic structural diagram of an embodiment of an apparatus for generating a video according to the present disclosure; and

FIG. 6 is a schematic structural diagram of an electronic device suitable for implementing embodiments of the present disclosure.

### DETAILED DESCRIPTION OF THE INVENTION

The present disclosure will be further described in detail below with reference to the accompanying drawings and embodiments. It may be understood that the embodiments described herein are only used to explain the relevant disclosure, but not to limit the disclosure. In addition, it should be noted that, for ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

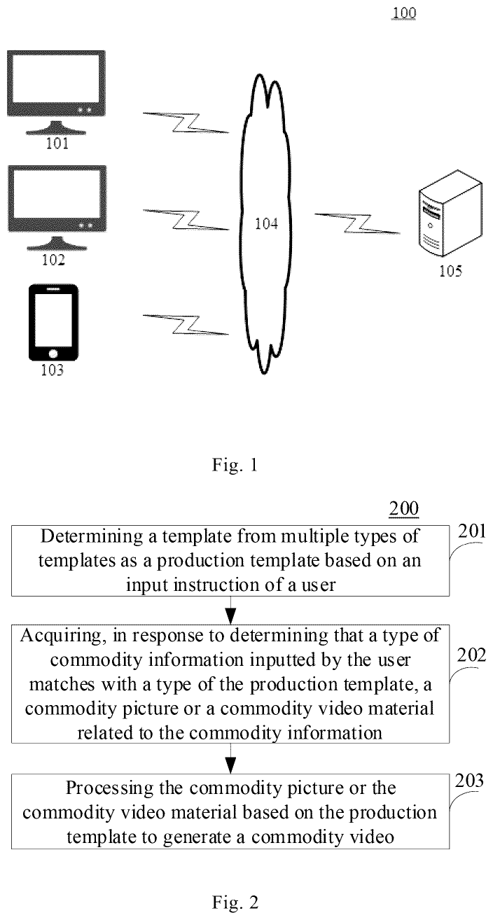

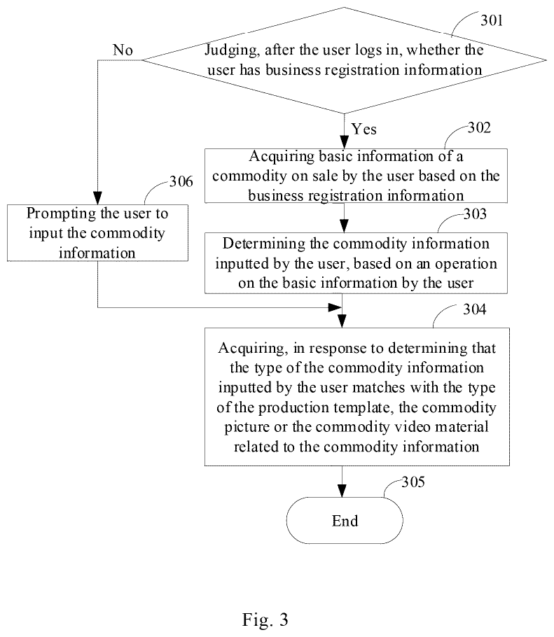

FIG. 1 shows an exemplary system architecture 100 to which a method for generating a video of the present disclosure may be applied.

As shown in FIG. 1, the system architecture 100 may include terminal devices 101, 102, and 103, a network 104, and a server 105. The network 104 serves as a medium providing a communication link between the terminal devices 101, 102, 103, and the server 105. The network 104 may include various types of connections, usually may include wireless communication links, etc.

The terminal devices 101, 102, and 103 interact with the server 105 via the network 104 to receive or send messages, etc. The terminal devices 101, 102, and 103 may be installed with various communication client applications, such as instant messaging tools, or email clients.

The terminal devices 101, 102, and 103 may be hardware or software. When the terminal devices 101, 102, and 103 are hardware, they may be user equipment having communication and control functions, and the above user equipment may communicate with the server 105. When the terminal devices 101, 102, 103 are software, they may be installed in the above user equipment. The terminal devices 101, 102, and 103 may be implemented as a plurality pieces of software or a plurality of software modules (e.g., software or software modules used to provide distributed services), or as a single piece of software or a single software module, which is not limited herein.

The server 105 may be a server that provides various services, such as a backend server for video generation that provides support for an image processing system on the terminal devices 101, 102, and 103. The backend server may analyze and process relevant information of each commodity on sale online in the network, and feedback a processing result (such as a video generation result) to the terminal devices.

It should be noted that the server may be hardware or software. When the server is hardware, it may be implemented as a distributed server cluster composed of multiple servers, or as a single server. When the server is software, it may be implemented as a plurality pieces of software or a plurality of software modules (e.g., software or software modules used to provide distributed services), or as a single piece of software or a single software module, which is not limited herein.

It should be noted that the method for generating a video provided by embodiments of the present disclosure is generally performed by the server 105.

It should be understood that the numbers of terminal devices, networks, and servers in FIG. 1 are only illustrative. Depending on implementation needs, there may be any number of terminal devices, networks, and servers.

As shown in FIG. 2, a flow 200 of an embodiment of a method for generating a video according to the present disclosure is illustrated, and the method for generating a video includes the following steps.

Step 201, determining a template from multiple types of templates as a production template based on an input instruction of a user.

In the present embodiment, an executing body on which the method for generating a video runs may provide a video generation interface for a user having video production needs, and display multiple types of templates on the video generation interface. The user inputs the instruction on the video generation interface, and the executing body determines the production template based on the input instruction of the user, where the multiple types of templates are used to distinguish different types of commodities, and the multiple types of templates are used to display different characteristics of each type of commodity. The different types include: sports, leisure, and the like, for example, for sportswear, a sports template is used to produce a main picture video, fast-paced audio plus lively special effects on the sports template can highlight characteristics of the commodity.

In the present embodiment, each type of template is a data structure that defines music to be used, various types of animation as well as an entry method and time, transition, text and special effects in the video. Each type of template is the basis for video production, and determining the production template may reuse preset information on the production template, such as specifical events, special effects, music, selling points, when producing the commodity video.

In the present embodiment, before producing the commodity video, the user may select a type of template based on the type. Alternatively, the executing body may also record usage of types of templates, when a type of template is used one time, the corresponding usage of this type of template is accumulated; further, the executing body may also recommend different types of templates based on the usage (e.g., top three usage), and a specific recommendation method may be: adding a recommendation tag for the top three usage types of templates, so that the user may select a type of template as the production template according to preference or recommendation.

Step 202, acquiring, in response to determining that a type of commodity information inputted by the user matches with a type of the production template, a commodity picture or a commodity video material related to the commodity information.

In the present embodiment, after the user inputs the instruction to the video generation interface and determines the production template, the executing body on which the method for generating a video runs may further acquire the commodity information inputted by the user through the video generation interface, and determine a production material for generating a video based on the commodity information. The production material may be the commodity picture or the commodity video material.

In the present embodiment, the commodity information inputted by the user includes: commodity code, commodity name, commodity cover picture, commodity picture, commodity promotion video, commodity interpretation video, commodity display video, and the like. Further, the executing body may acquire the commodity picture or the commodity video material related to the commodity information through the commodity information (e.g., the commodity code, the commodity name, the commodity cover picture) inputted by the user.

In an actual scenario, the executing body may also acquire a commodity detail page on a web page based on the commodity code inputted by the user, and generate a video based on the production template, after processing the commodity detail page through steps such as intelligent selection of picture, erasing of picture impurity, intelligent cropping, and extraction of selling point.

In the present embodiment, the commodity picture may be a picture of various dimensions, various angles of the commodity; and the commodity video material may be material such as the commodity promotion video, the commodity interpretation video, or the commodity display video.

In some alternative implementations of the present embodiment, the commodity information inputted by the user may be the commodity code, or the commodity picture or the commodity video material, and the commodity information inputted by the user may further include: the commodity code, the commodity picture corresponding to the commodity code or the commodity video material. That is, the commodity information inputted by the user may be any one of the commodity code, the commodity picture, or the commodity video material. In the present embodiment, if the commodity information is not acquired, the commodity video cannot be generated.

In the present embodiment, the type of the commodity information inputted by the user may be either one or two types. When the type of the commodity information inputted by the user is one type, the type of the production template needs to be the same as the type of the commodity information inputted by the user. When the type of the commodity information inputted by the user is more than two types, the production template may be a general template. The general template is a template available for all types of commodities, without characteristics of personalized types, for example, a non-general sports template may add some sports elements or copywriting descriptions.

Step 203, processing the commodity picture or the commodity video material based on the production template to generate a commodity video.

In the present embodiment, the production template is a reference template for the to-be-generated commodity video. The production template provides a video layout reference for the commodity video, and the production template defines content, such as music, types of animation as well as animated character entry method and time, transition, text and special effects, involved in the commodity video. According to the content defined in the production template, the commodity picture or the commodity video material is processed to generate the commodity video.

In the present embodiment, processing the commodity picture or the commodity video material, may be some simple picture processing, such as picture translation, zooming, may also be some complex transformations, such as technological sense of flashing, or 3D rotation, or may also be animation designed by a designer, which is usually an animation format formed by multiple pictures according to a method such as cutting, splicing, or complex spatial movements.

Alternatively, in the process of generating the commodity video based on the production template, commodity selling points may be directly added during the video generation or after the commodity video is generated. Commodity selling points are language and presentation extracted to display characteristics and advantages of one's own products. Further, in order to enhance attractiveness of the commodity video, filter and special effects processing may be performed on the commodity video, which can make the video present different styles, and enrich appeal of the video.

In some alternative implementations of the present embodiment, processing the commodity picture or the commodity video material based on the production template to generate a commodity video, includes: transferring music in the production template or music in the commodity video material to a frequency domain, calculating local extrema of audio energy and misalignment convolution, and determining accent points and beats; generating the commodity picture into an initial video and extracting multiple video segments of a preset duration from the initial video, or extracting multiple video segments of a preset duration from the video material; and merging the multiple video segments in a form of transition animation based on the accent points and the beats, to generate the commodity video.

In this alternative implementation, multiple animation generation functions may be used to generate the initial video from one or more commodity pictures. Multiple video segments of the preset duration may be extracted from the initial video or the video material using a video abstract extraction model.

In this alternative implementation, transition animation, also known as transition between scenes, specifically, the transition between scenes may be achieved through OPENGL (Open Graphics Library). In this alternative implementation, the use of OPENGL to achieve the transition between scenes may obtain nearly 100 kinds of video transition effects, for example, transition includes a fade black to fade light transition effect.

In this alternative implementation, by calculating the local extrema of the audio energy, the accent points of the music are determined, and by calculating the misalignment convolution, the beats of the music are determined. The extracted multiple video segments are merged in the form of transition animation based on the accent points and the beats, which may ensure that video transition points are at the same pace as a video soundtrack.

In some alternative implementations of the present embodiment, processing the commodity picture includes: pre-processing the commodity picture; identifying a text area of the pre-processed picture; and removing text content in the text area.

In this alternative implementation, pre-processing includes: splicing of cut pictures, cutting of multi-subject picture, screening and filtering of picture, erasing of image impurity, intelligent cropping and splicing of pictures, and uniform designing of picture size. In this alternative implementation, deep learning OCR (Optical Character Recognition) may be used to recognize the text area and the text content of the pre-processed picture. A conventional text picture-erasing model may be used to erase the text content in the text area to ensure that the generated video is clear and tidy.

In this alternative implementation, first of all, pre-processing the commodity picture, when there are multiple commodity pictures, they may have a uniform specification size. By identifying the text area of the pre-processed picture and removing the text content in the text area, it may be ensured that the generated commodity video is clear and tidy.

In some alternative implementations of the present embodiment, before removing the text content in the text area, a language model may also be used to extract key information in the text content, and write the extracted key information into the commodity video. In this alternative implementation, the key information is commodity selling points in the form of text. Writing the commodity selling points to the commodity vide, may facilitate the user to quickly discover selling point information of the commodity in the commodity video.

In some alternative implementations of the present embodiment, sending, in response to determining that the type of the commodity information inputted by the user does not match with the type of the production template, a prompt message for prompting replacement of the production template.

In this alternative implementation, when the type of the commodity information inputted by the user does not match with the type of the production template, the user is prompted in time to re-input an instruction by the prompt message, ensuring that a style of the generated video matches with a style required by the user to the maximum, so that the subsequent generated commodity video may achieve an optimal production effect.

In some other alternative implementations of the present embodiment, in response to determining that the type of the commodity information inputted by the user does not match with the type of the production template, a matching template may further be recommended to the user, thereby achieving a better production effect.

In some alternative implementations of the present embodiment, after generating the commodity video, the method may further include: binding the commodity video to a commodity code; and uploading the commodity video bound to the commodity code to a promotional display position of a main picture of the commodity.

In this alternative implementation, by binding the commodity video to the commodity code, a production efficiency of the commodity video is improved, which may make production time of a single commodity video around 40s. At the same time, the commodity video may be produced in batches, significantly improving the efficiency.

The method provided by embodiments of the present disclosure, first determines a template from multiple types of templates as a production template based on an input instruction of a user; secondly acquires, in response to determining that a type of commodity information inputted by the user matches with a type of the production template, a commodity picture or a commodity video material related to the commodity information; and finally processes the commodity picture or the commodity video material based on the production template to generate a commodity video. Therefore, through the determination of the production template by interacting with the user, and based on the production template and the acquired commodity picture or commodity video material, the commodity video is generated, a flow of video production is simplified, and the video production efficiency is improved.

In the present embodiment, the commodity information may be online commodity of the user or commodity on sale by the user. The executing body on which the method for generating a video runs may determine whether to automatically recommend the commodity information to the user based on commodity registration information of the user. In some alternative implementations of the present embodiment, the method for acquiring a commodity picture or a commodity video material related to the commodity information, includes the following steps.

Step 301, judging, after the user logs in, whether the user has business registration information; in response to a judgment result being that the user has the business registration information, then, performing step 302; in response to the judgement result being that the user does not have the business registration information, then, performing step 306.

In this alternative implementation, the user needs to register in a video generation system provided by the executing body, and after successful registration, logs in the video generation system, selects the production template through the video generation interface and inputs the commodity information.

In this alternative implementation, the business registration information indicates that the user has a business account registered in the video generation system, through the business account, it may be determined whether the user has a commodity on sale, and basic information of the commodity on sale may be obtained after determining that there is a commodity on sale.

Step 302, acquiring basic information of a commodity on sale by the user based on the business registration information, then, performing step 303.

In this alternative implementation, the basic information of the commodity on sale refers to information such as code (SKU, stock keeping unit), commodity name, or commodity cover picture of the commodity on sale.

Step 303, determining the commodity information inputted by the user, based on an operation on the basic information by the user, then, performing step 304.

In this alternative implementation, the basic information of the commodity on sale may be directly displayed on the video generation interface, and the user may directly perform an operation such as clicking or inputting the code, the commodity cover picture, or the commodity name of the commodity on sale, with reference to display content on the video generation interface to determine the commodity information inputted by the user. Of course, the basic information of the commodity on sale may also be displayed on an operation interface to which the user logs in. After the user performs an operation such as directly clicking the basic information of the commodity on sale or inputting the code, the commodity cover picture, or the commodity name of the commodity on sale, the operation interface is no longer displayed.

In this alternative implementation, when the user has the business account, the executing body may acquire the commodity on sale of the business from a backend server, allowing the user of the business to directly select the commodity information that needs to be inputted from the basic information of the commodity on sale when producing video, without inputting the commodity information.

Further, the commodity information inputted by the user may be obtained from the basic information of the commodity on sale, which improves the convenience of user selection, when the user forgets or cannot determine the commodity information.

Step 304, acquiring, in response to determining that the type of the commodity information inputted by the user matches with the type of the production template, the commodity picture or the commodity video material related to the commodity information, then, performing step 305.

In this alternative implementation, when the user does not have a business account, the user needs to directly input the commodity information of the commodity on sale in the mall, and the commodity information includes the commodity code, a link of the commodity, etc. Further, the video is generated based on the commodity information. Alternatively, the video may be generated based on a commodity SKUID, SKU link. Alternatively, the video may also be generated based on a picture or a video material added by the user.

Step 305, exiting.

Step 306, prompting the user to input the commodity information, then, performing step 304.

In this alternative implementation, a preset prompt message may be displayed in the operation interface to which the user logs in, to prompt the user to input the commodity information. Here, the operation interface may also be an interface to which the user to inputs the commodity information.

In this alternative implementation, after the user that has the business account adds the commodity information, the system may again judge whether the type of the commodity information matches with the type of the production template, if not matched, a matching template may be recommended, to achieve a better production effect of the commodity video.

The method for acquiring a commodity picture or a commodity video material related to the commodity information provided by this alternative implementation, determines the basic information of the commodity on sale by the user based on the business registration information, when the user has the business registration information, and determines the commodity information inputted by the user based on the operation on the basic information by the user. Therefore, when interacting with the user, based on the basic information of the commodity on sale by the user, the commodity information is automatically recommended to the user, which improves the video production efficiency.

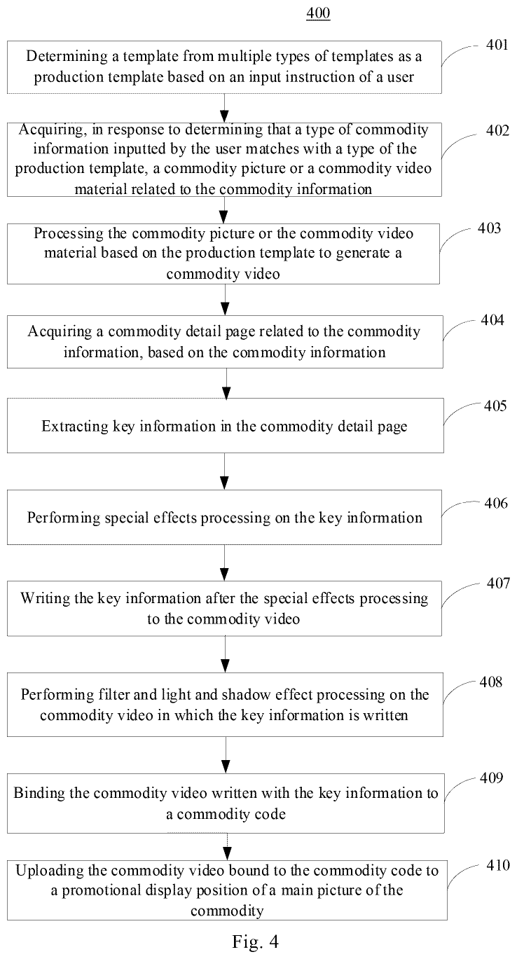

In order that the generated video has a better display effect, with further reference to FIG. 4, illustrating a flow 400 of another embodiment of the method for generating a video according to the present disclosure. The method for generating a video includes the following steps.

Step 401, determining a template from multiple types of templates as a production template based on an input instruction of a user.

Step 402, acquiring, in response to determining that a type of commodity information inputted by the user matches with a type of the production template, a commodity picture or a commodity video material related to the commodity information.

Step 403, processing the commodity picture or the commodity video material based on the production template to generate a commodity video.

It should be understood that the operations and features in step 401 to step 403 above correspond to the operations and features in step 201 to step 203, respectively, therefore, the description of the operations and features in step 401 to step 403 above is equally applicable to step 201 to step 203, detailed description thereof will be omitted herein.

Step 404, acquiring a commodity detail page related to the commodity information, based on the commodity information.

In the present embodiment, the commodity detail page is a commodity detail page produced by a commodity seller, which describes detailed description information such as origin, manufacturer, specifications, or scope of application of the commodity. The detailed description information may include videos, pictures, text descriptions of the commodity. For example, on a web page, the commodity detail page may be viewed by clicking on a picture in the promotional display position of a commodity.

Step 405, extracting key information in the commodity detail page.

In the present embodiment, the key information may be information representing features of the commodity, for example, text, pictures, videos, and the extracted key information may reflect the commodity selling points.

In some alternative implementations of the present embodiment, the key information may be text, the extracting key information in the commodity detail page, includes: extracting the key information in the commodity detail page using a language model, the language model being obtained from training based on the type of the production template.

Different BERT (Bidirectional Encoder Representations from Transformers) language models may be trained for different commodity types. Using the language models, word segmentation, weight setting and semantic understanding may be performed on OCR recognized text, to extract several pieces of concise phrases from large paragraphs of text or multiple sentences of text as a promotional copywriting of the commodity selling points. Here, weight setting refers to: selecting a part of commodity copywriting as calibration samples from language model samples, after word segmentation, giving to a calibration team for the calibration according to business needs, then training a weight for each word using the language model based on the data.

In this alternative implementation, by using the language model, the key information of the text in the commodity detail page may be effectively extracted, thus improving an efficiency of commodity selling point extraction.

Step 406, performing special effects processing on the key information.

In the present embodiment, special effects may be set according to user-specified business needs to achieve a variety of display effects, for example, special effects add some light and shadow or particles to the key information.

Step 407, writing the key information after the special effects processing into the commodity video.

In the present embodiment, the key information after the special effects processing realizes a variety of styles of display effects for the selling points. For example, when the key information is text, a variety of text display effects are realized.

Step 408, performing filter and light and shadow effect processing on the commodity video in which the key information is written.

In the present embodiment, filters are mainly used to achieve various special effects on images. Light and shadow effect processing gives objects in an image a shadow effect formed by the sunlight. Several common filters and the light and shadow effect are applied to the commodity video, which can make the commodity video present different styles, and enrich appeal of the commodity video.

Step 409, binding the commodity video written with the key information to a commodity code.

In the present embodiment, the commodity video is bound to the commodity code, so that it is easy to find the commodity relative to the commodity code. For example, commodity videos of codes of 5 commodities are generated together in a batch, then the produced commodity videos are automatically associated to these 5 commodities. By binding the commodity video to the commodity code, a production efficiency of the commodity video is improved, which may make production time of a single commodity video around 40s. At the same time, the commodity video may be produced in batches, significantly improving the efficiency.

Step 410, uploading the commodity video bound to the commodity code to a promotional display position of a main picture of the commodity.

In the present embodiment, the generated commodity video may be uploaded to the promotional display position of the main picture of the commodity. When browsing the commodity, the user may have a comprehensive understanding of the appearance, characteristics and selling points of the commodity by viewing the commodity video. Further, the commodity video may be uploaded to the promotional display position of the main picture of the commodity through a video review system, which is used to review whether the commodity conforms to a preset video specification, and the preset video specification is governed by a special specification document.

After video generation is complete, the video review system judges that the video generation is complete, and performs review and judgement on the commodity video. If the review is approved, the commodity video is displayed in a position of the commodity detail page (i.e., the promotional display position of the main picture of the commodity).

In the present embodiment, by uploading the commodity video to the promotional display position of the main picture of the commodity, it can strengthen the promotion of commodity characteristics, attract buyers, and strengthen the diversion to orders until conversion.

The method for generating a video provided by the present embodiment, acquires the commodity detail page related to the commodity information, based on the commodity information, extracts the key information in the commodity detail page, performs special effects processing on the key information and writes the key information after the special effects processing into the commodity video, and performs filter and light and shadow effect processing on the commodity video written with the key information. Through the extracted key information, the selling points of the commodity are obtained, through performing special effects processing on the key information, display effects of the selling points are improved; through performing filter and light and shadow effect processing on the commodity video written with the key information, overall coordination of the selling points in the commodity video is improved, and the display effect of the commodity video is also improved.

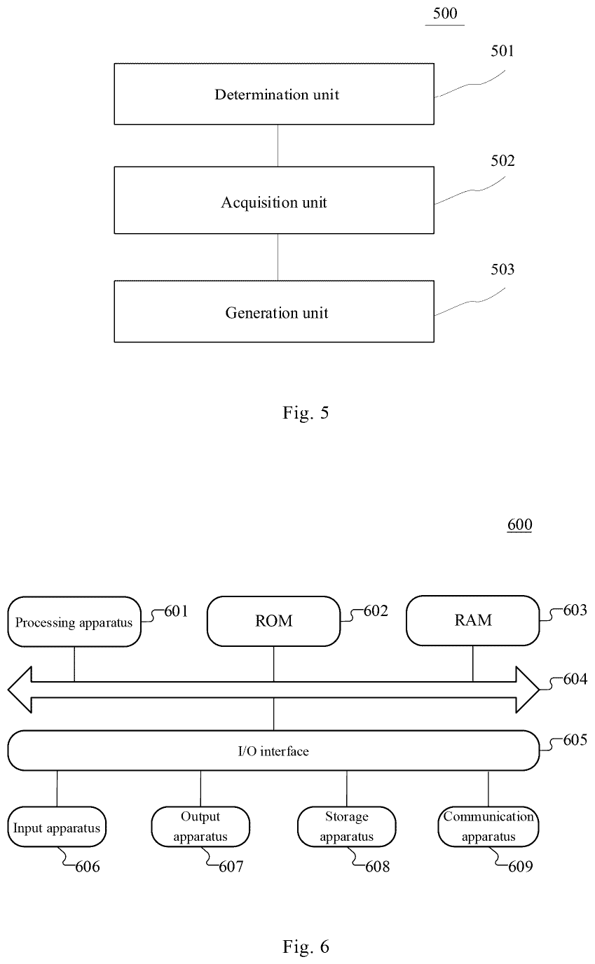

With further reference to FIG. 5, as an implementation of the method shown in the above Figures, the present disclosure provides an embodiment of an apparatus for generating a video. The embodiment of the apparatus corresponds to the embodiment of the method shown in FIG. 2. The apparatus may be applied to various electronic devices.

As shown in FIG. 5, an embodiment of the present disclosure provides an apparatus 500 for generating a video, the apparatus 500 includes: a determination unit 501, an acquisition unit 502, and a generation unit 503. The determination unit 501 may be configured to determine a template from multiple types of templates as a production template based on an input instruction of a user. The acquisition unit 502 may be configured to acquire, in response to determining that a type of commodity information inputted by the user matches with a type of the production template, a commodity picture or a commodity video material related to the commodity information. The generation unit 503 may be configured to process the commodity picture or the commodity video material based on the production template to generate a commodity video.

In the present embodiment, in the apparatus 500 for generating a video, for the specific processing and technical effects of the determination unit 501, the acquisition unit 502, and the generation unit 503, reference may be made to step 201, step 202, and step 203 in the corresponding embodiment of FIG. 2.

In some embodiments, the generation unit 503 includes: a calculation module (not shown in the figure), an extraction module (not shown in the figure), and a generation module (not shown in the figure). The calculation module may be configured to transfer music in the production template or music in the commodity video material to a frequency domain, calculate local extrema of audio energy and misalignment convolution, and determine accent points and beats. The extraction module may be configured to generate the commodity picture into an initial video and extract multiple video segments of a preset duration from the initial video, or extract multiple video segments of a preset duration from the video material. The generation module may be configured to merge the multiple video segments in a form of transition animation based on the accent points and the beats, to generate the commodity video.

In some embodiments, the acquisition unit 502 includes: a judgement module (not shown in the figure), an acquisition module (not shown in the figure), a determination module (not shown in the figure), a responding module (not shown in the figure), and a prompting module (not shown in the figure). The judgement module may be configured to: judge, after the user logs in, whether the user has business registration information. The acquisition module may be configured to: acquire, in response to a judgment result being that the user has the business registration information, basic information of a commodity on sale by the user based on the business registration information. The determination module may be configured to: determine the commodity information inputted by the user, based on an operation on the basic information by the user. The responding module may be configured to: acquire, in response to determining that the type of the commodity information inputted by the user matches with the type of the production template, the commodity picture or the commodity video material related to the commodity information. The prompting module may be configured to: prompt, in response to the judgement result being that the user does not have the business registration information, the user to input the commodity information, and trigger the responding module to work.

In some embodiments, the apparatus 500 further includes: a detailed unit (not shown in the figure), an extraction unit (not shown in the figure), a special-effects unit (not shown in the figure), and a processing unit (not shown in the figure). The detailed unit may be configured to acquire a commodity detail page related to the commodity information, based on the commodity information. The extraction unit may be configured to extract key information in the commodity detail page. The special-effects unit may be configured to perform special effects processing on the key information, and write the special-effects-processed key information into the commodity video. The processing unit may be configured to perform filter and light and shadow effect processing on the commodity video in which the key information is written.

In some embodiments, the extraction unit is further configured to: extract the key information in the commodity detail page using a language model, the language model being obtained from training based on the type of the production template.

In some embodiments, the generation unit 503 includes: a pre-processing module (not shown in the figure), an identification module (not shown in the figure), and a removal module (not shown in the figure). The pre-processing module may be configured to pre-process the commodity picture. The identification module may be configured to identify a text area of the pre-processed picture. The removal module may be configured to remove text content in the text area.

In some embodiments, the apparatus 500 further includes: a binding unit (not shown in the figure) and an uploading unit (not shown in the figure). The binding unit may be configured to bind the commodity video to a commodity code. The uploading unit may be configured to upload the commodity video bound to the commodity code to a promotional display position of a main picture of the commodity.

In some embodiments, the apparatus 500 further includes: a sending unit (not shown in the figure). The sending unit may be configured to send, in response to determining that the type of the commodity information inputted by the user does not match with the type of the production template, a prompt message for prompting replacement of the production template.

The apparatus for generating a video provided by an embodiment of the present disclosure, first the determination unit 501 determines a template from multiple types of templates as a production template based on an input instruction of a user; secondly the acquisition unit 502 acquires, in response to determining that a type of commodity information inputted by the user matches with a type of the production template, a commodity picture or a commodity video material related to the commodity information; and finally the generation unit 503 processes the commodity picture or the commodity video material based on the production template to generate a commodity video. Therefore, through the determination of the production template by interacting with the user, and based on the production template and the acquired commodity picture or commodity video material, the commodity video is generated, a threshold for video production is lowered, and a simple and convenient operation mode is provided for the user, which facilitates usage by the user, and improves user experience.

With further reference to FIG. 6, a schematic structural diagram of an electronic device 600 suitable for implementing embodiments of the present disclosure is shown.

As shown in FIG. 6, the electronic device 600 may include a processing apparatus (such as a central processing unit, a graphics processor) 601, which may execute various appropriate actions and processes in accordance with a program stored in a read-only memory (ROM) 602 or a program loaded into a random access memory (RAM) 603 from a storage apparatus 608. The RAM 603 also stores various programs and data required by operations of the electronic device 600. The processing apparatus 601, the ROM 602 and the RAM 603 are connected to each other through a bus 604. An input/output (I/O) interface 605 is also connected to the bus 604.

Typically, the following apparatuses may be connected to the I/O interface 605: an input apparatus 606 including a touch screen, a touch pad, a keyboard, or a mouse; an output apparatus 607 including such as a liquid crystal display (LCD), a speaker, or a vibrator; the storage apparatus 608 including such as a magnetic tape, or a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood, however, that not all shown apparatuses are required to be implemented or provided. More or fewer apparatuses may alternatively be implemented or provided. Each block shown in FIG. 6 may represent one apparatus, or may represent a plurality of apparatuses as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication apparatus 609, or may be installed from the storage apparatus 608, or may be installed from the ROM 602. The computer program, when executed by the processing apparatus 601, implements the above-mentioned functionalities as defined by the method of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The computer readable medium may be included in the server, or a stand-alone computer readable medium not assembled into the server. The computer readable medium carries one or more programs. The one or more programs, when executed by the server, cause the server to: determine a template from multiple types of templates as a production template based on an input instruction of a user; acquire, in response to determining that a type of commodity information inputted by the user matches with a type of the production template, a commodity picture or a commodity video material related to the commodity information; and process the commodity picture or the commodity video material based on the production template to generate a commodity video.

A computer program code for performing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure may be implemented by means of software or hardware. The described units may also be provided in a processor, for example, may be described as: a processor including a determination unit, an acquisition unit, and a generation unit. Here, the names of these units do not in some cases constitute limitations to such units themselves. For example, the determination unit may also be described as “a unit configured to determine a template from multiple types of templates as a production template based on an input instruction of a user”.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

1. A method for generating a video, the method comprising:
determining a template from multiple types of templates as a production template based on an input instruction of a user;
acquiring, in response to determining that a type of commodity information inputted by the user matches with a type of the production template, a commodity picture or a commodity video material related to the commodity information; and
processing the commodity picture or the commodity video material based on the production template to generate a commodity video.

2. The method according to claim 1, wherein processing the commodity picture or the commodity video material based on the production template to generate the commodity video, comprises:
transferring music in the production template or music in the commodity video material to a frequency domain, calculating local extrema of audio energy and misalignment convolution, and determining accent points and beats;
generating the commodity picture into an initial video and extracting multiple video segments of a preset duration from the initial video, or extracting multiple video segments of a preset duration from the video material; and
merging the multiple video segments in a form of transition animation based on the accent points and the beats, to generate the commodity video.

3. The method according to claim 1, wherein acquiring, in response to determining that the type of commodity information inputted by the user matches with the type of the production template, the commodity picture or the commodity video material related to the commodity information, comprises:
judging, after the user logs in, whether the user has business registration information;
acquiring, in response to a judgment result being that the user has the business registration information, basic information of a commodity on sale by the user based on the business registration information;
determining the commodity information inputted by the user, based on an operation on the basic information by the user; and acquiring, in response to determining that the type of the commodity information inputted by the user matches with the type of the production template, the commodity picture or the commodity video material related to the commodity information; and
prompting, in response to the judgement result being that the user does not have the business registration information, the user to input the commodity information, and acquiring, in response to determining that the type of the commodity information inputted by the user matches with the type of the production template, the commodity picture or the commodity video material related to the commodity information.

4. The method according to claim 1, wherein the method further comprises:
acquiring a commodity detail page related to the commodity information, based on the commodity information;
extracting key information in the commodity detail page;
performing special effects processing on the key information, and writing the key information after the special effects processing into the commodity video; and
performing filter and light and shadow effect processing on the commodity video in which the key information is written.

5. The method according to claim 4, wherein extracting the key information in the commodity detail page, comprises:
extracting the key information in the commodity detail page using a language model, the language model being obtained from training based on the type of the production template.

6. The method according to claim 1, wherein processing the commodity picture, comprises:
pre-processing the commodity picture;
identifying a text area of the pre-processed picture; and
removing text content in the text area.

7. The method according to claim 1, wherein the method further comprises:
binding the commodity video to a commodity code; and
uploading the commodity video bound to the commodity code to a promotional display position of a main picture of the commodity.

8. The method according to claim 1, wherein the method further comprises:
sending, in response to determining that the type of the commodity information inputted by the user does not match with the type of the production template, a prompt message for prompting replacement of the production template.

9. An apparatus for generating a video, the apparatus comprising:
one or more processors; and
a storage apparatus, storing one or more programs thereon,
wherein the one or more programs, when executed by the one or more processors, cause the one or more processors to perform operations, the operations comprising:
determining a template from multiple types of templates as a production template based on an input instruction of a user;
acquiring, in response to determining that a type of commodity information inputted by the user matches with a type of the production template, a commodity picture or a commodity video material related to the commodity information; and
processing the commodity picture or the commodity video material based on the production template to generate a commodity video.

10. The apparatus according to claim 9, wherein processing the commodity picture or the commodity video material based on the production template to generate the commodity video, comprises:
transferring music in the production template or music in the commodity video material to a frequency domain, calculating local extrema of audio energy and misalignment convolution, and determining accent points and beats;
generating the commodity picture into an initial video and extracting multiple video segments of a preset duration from the initial video, or extracting multiple video segments of a preset duration from the video material; and
merging the multiple video segments in a form of transition animation based on the accent points and the beats, to generate the commodity video.

11. The apparatus according to claim 9, wherein acquiring, in response to determining that the type of commodity information inputted by the user matches with the type of the production template, the commodity picture or the commodity video material related to the commodity information, comprises:
judging, after the user logs in, whether the user has business registration information;
acquiring, in response to a judgment result being that the user has the business registration information, basic information of a commodity on sale by the user based on the business registration information;
determining the commodity information inputted by the user, based on an operation on the basic information by the user;
acquiring, in response to determining that the type of the commodity information inputted by the user matches with the type of the production template, the commodity picture or the commodity video material related to the commodity information; and
prompting, in response to the judgement result being that the user does not have the business registration information, the user to input the commodity information, and acquiring, in response to determining that the type of the commodity information inputted by the user matches with the type of the production template, the commodity picture or the commodity video material related to the commodity information.

12. The method according to claim 9, wherein the operations further comprises:
acquiring a commodity detail page related to the commodity information, based on the commodity information;
extracting key information in the commodity detail page;
performing special effects processing on the key information, and writing the key information after the special effects processing into the commodity video; and
performing filter and light and shadow effect processing on the commodity video in which the key information is written.

13. The apparatus according to claim 12, wherein extracting the key information in the commodity detail page, comprises: extracting the key information in the commodity detail page using a language model, the language model being obtained from training based on the type of the production template.

14. The apparatus according to claim 9, wherein processing the commodity picture, comprises:
pre-processing the commodity picture;
identifying a text area of the pre-processed picture; and
removing text content in the text area.

15. The apparatus according to claim 9, wherein the operations further comprises:
binding the commodity video to a commodity code; and
uploading the commodity video bound to the commodity code to a promotional display position of a main picture of the commodity.

16. The apparatus according to claim 9, wherein the operations further comprises:
sending, in response to determining that the type of the commodity information inputted by the user does not match with the type of the production template, a prompt message for prompting replacement of the production template.

17. (canceled)

18. A non-transitory computer readable medium, storing a computer program thereon, wherein the program when executed by a processor, causes the processor to perform operations, the operations comprising:
determining a template from multiple types of templates as a production template based on an input instruction of a user;
acquiring, in response to determining that a type of commodity information inputted by the user matches with a type of the production template, a commodity picture or a commodity video material related to the commodity information; and
processing the commodity picture or the commodity video material based on the production template to generate a commodity video.

19. The non-transitory computer readable medium according to claim 18, wherein processing the commodity picture or the commodity video material based on the production template to generate the commodity video, comprises:
transferring music in the production template or music in the commodity video material to a frequency domain, calculating local extrema of audio energy and misalignment convolution, and determining accent points and beats;
generating the commodity picture into an initial video and extracting multiple video segments of a preset duration from the initial video, or extracting multiple video segments of a preset duration from the video material; and
merging the multiple video segments in a form of transition animation based on the accent points and the beats, to generate the commodity video.

20. The non-transitory computer readable medium according to claim 18, wherein acquiring, in response to determining that the type of commodity information inputted by the user matches with the type of the production template, the commodity picture or the commodity video material related to the commodity information, comprises:
judging, after the user logs in, whether the user has business registration information;
acquiring, in response to a judgment result being that the user has the business registration information, basic information of a commodity on sale by the user based on the business registration information;
determining the commodity information inputted by the user, based on an operation on the basic information by the user; and acquiring, in response to determining that the type of the commodity information inputted by the user matches with the type of the production template, the commodity picture or the commodity video material related to the commodity information; and
prompting, in response to the judgement result being that the user does not have the business registration information, the user to input the commodity information, and acquiring, in response to determining that the type of the commodity information inputted by the user matches with the type of the production template, the commodity picture or the commodity video material related to the commodity information.

21. The non-transitory computer readable medium according to claim 18, wherein the method further comprises:
acquiring a commodity detail page related to the commodity information, based on the commodity information;
extracting key information in the commodity detail page;
performing special effects processing on the key information, and writing the key information after the special effects processing into the commodity video; and
performing filter and light and shadow effect processing on the commodity video in which the key information is written.
